(19) United States
(12) Patent Application Publication
(10) Pub. No.: US 2014/0106179 A1
(43) Pub. Date: Apr. 17, 2014

(54) PLATING DESIGN AND PROCESS FOR IMPROVED HERMETICITY AND THERMAL CONDUCTIVITY OF GOLD-GERMANIUM SOLDER JOINTS

(71) Applicant: RAYTHEON COMPANY, Waltham, MA (US)

(72) Inventor: Wesley M. Wolverton, Richardson, TX (US)

(73) Assignee: RAYTHEON COMPANY, Waltham, MA (US)

(21) Appl. No.: 13/654,024

(22) Filed: Oct. 17, 2012

(51) Int. Cl. B23K 31/02; B23K 31/12; B32B 3/26

(52) U.S. Cl. 428/613; 228/101; 228/176; 228/103

(57) ABSTRACT

A solder joint and method of soldering are disclosed. Formation is controlled of atomic vacancies in a surface layer of a component to be soldered. Diffusion of the atomic vacancies during soldering is controlled. Vacancy formation may be controlled using a low current density during surface layer creation. Diffusion may be controlled by controlling layer thickness and soldering temperature.

### BACKGROUND

The present disclosure relates to soldering, and more specifically, to a method of forming a solder joint with improved hermeticity and thermal conductivity.

Various devices are housed in casings that may be required to have a certain level of hermeticity or air-tightness. These same casings may be required to have a certain thermal conductivity in order to dissipate heat generated by the device(s) housed therein. These casings may include two or more components that are soldered together. To solder a component, a surface plating finish, generally a nickel metal, is formed on a surface of the component using ion deposition. A gold-germanium solder is then applied to the surface plating finish and heated above a solder reflow temperature to create the solder joint. Current methods of ion deposition create vacancies at atomic lattice locations in the surface plating finish. When the surface plating finish is heated during the soldering process, the resulting diffusion of metals causes the vacancies to aggregate and form voids in the solder joint. Voids that are large and/or interconnected may provide a passage for air to infiltrate the solder joint, thus reducing the hermeticity of the solder joint. Thermal conductivity is also affected by the presence of voids in the solder joint.

### SUMMARY

According to one embodiment of the present disclosure, a method of soldering a component includes: controlling a formation of atomic vacancies in a surface layer of the component; and controlling a diffusion rate of the atomic vacancies during soldering of the material.

According to another embodiment, a method of improving a hermeticity of a solder joint includes: controlling a formation of atomic vacancies in a material forming the solder joint; and controlling a diffusion rate of the atomic vacancies during soldering of the material to form the solder joint.

According to another embodiment, a solder joint, includes: a component; a surface plating finish formed on the component having a controlled number of atomic vacancies; and a solder layer and intermetallic compounds having a controlled number of voids.

Additional features and advantages are realized through the techniques of the present disclosure. Other embodiments and aspects of the disclosure are described in detail herein and are considered a part of the claimed disclosure. For a better understanding of the disclosure with the advantages and the features, refer to the description and to the drawings.

### BRIEF DESCRIPTION OF THE SEVERAL VIEWS OF THE DRAWINGS

The subject matter which is regarded as the disclosure is particularly pointed out and distinctly claimed in the claims at the conclusion of the specification. The forgoing and other features, and advantages of the disclosure are apparent from the following detailed description taken in conjunction with the accompanying drawings in which:

FIG. 1 shows an exemplary system for forming a surface plating finish on a component in one aspect of the present disclosure;

FIG. 2 shows an exemplary relation between an applied voltage and a current density during a process of surface plating finish formation;

FIG. 3 shows a schematic configuration of metals for forming an exemplary solder joint of the present disclosure;

FIG. 4 shows exemplary diffusion profiles at an interface between two layers;

FIG. 5 shows an exemplary graph of temperature dependence of diffusion coefficients;

FIG. 6 shows an exemplary soldering process temperature versus time profile;

FIG. 7 (Prior Art) shows a cross-section of a solder joint formed using standard methods of solder joint construction;

FIG. 8 shows a cross-section of an exemplary solder joint formed using exemplary methods disclosed herein;

FIG. 9 shows a flowchart illustrating an exemplary method of solder joint construction using the exemplary methods disclosed herein; and

FIG. 10 shows a flowchart illustrating an exemplary method of controlling a quality of a hermeticity of a solder joint.

### DETAILED DESCRIPTION

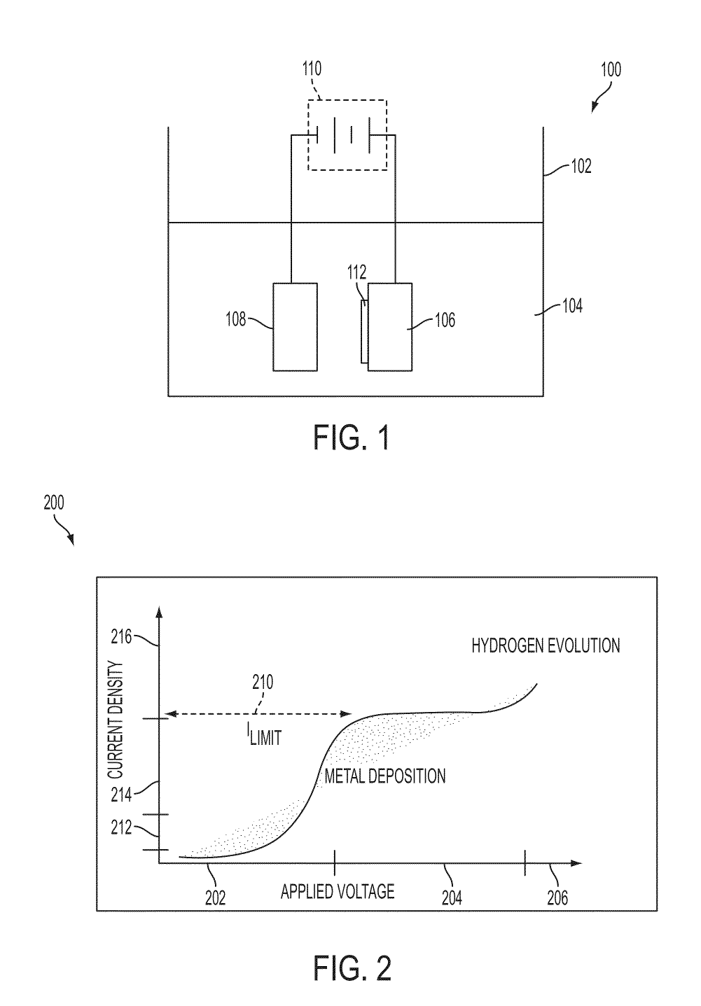

FIG. 1 shows an exemplary system 100 for forming a surface plating finish 112 on a component 106 in one embodiment of the present disclosure. The system 100 includes a container 102 that holds an electrolytic solution 104. A component 106 that is to be prepared for soldering is disposed in the solution 104 alongside a plating source metal 108 that provides metal ions that form the surface plating finish 112 on the component 106. In various embodiments, the plating source metal 108 is a nickel metal. The component 106 may be a casing or material used to form a solder joint. The system 100 further includes a controllable power supply 110. The component 106 is coupled to a cathode end of the power supply 110 and the plating source metal 108 is coupled to an anode end of the power supply 110. The power supply 110 provides a voltage potential between the plating source metal 108 and the component 106. As the voltage potential is applied between the plating source metal 110 and the component 106, metal ions are stripped from the plating source metal 108 and deposited onto a surface of the component 106. The metal ions deposit to form a crystalline structure that forms the surface plating finish 112. Metal ions (i.e., nickel ions) may alternatively or additionally be dissolved in the electrolytic solution in order to increase concentration of metal ions and a rate of ion deposition. The transfer of metal ions from the plating source metal 108 to the component 106 produces a current flow having a controllable current density.

FIG. 2 shows an exemplary relation 200 between an applied voltage and a current density during a process of depositing a surface plating finish 112 on a component 106 using the exemplary system of FIG. 1. Applied voltage is shown along the x-axis and current density is shown along the y-axis. In general, the rate of metal ion deposition at component 106 increases directly with the applied voltage. At low applied voltages (low voltage region 202), current density increases with voltage up to a plateau region. In the plateau region (an intermediate voltage region 204), the applied voltage may be increased without producing a substantial increase in current density. At high applied voltages (high voltage region 206), current density once again increases with applied voltage. The applied voltage may be applied to supply current in a region of low current density 212, intermediate current density 214 and high current density 216. In various embodiments, low current density 212 is in a range from about 0.2 amps per square decimeter (ASD) to about 5 ASD. The intermediate current density 214 may be in a range from about 5 ASD to about 20 ASD. The high current density 216 may be in a range above about 20 ASD. A current density limit 210 for hydrogen evolution is shown. At current densities above the current density limit 210, hydrogen evolution begins to occur. Hydrogen evolution is an electrode reaction in which hydrogen gas is produced at the cathode of an electrolytic cell by the reduction of hydrogen ions. When hydrogen evolution occurs, the metal ions tend to deposit on the surface of the component 106 in a non-uniform manner, causing vacancies to occur at atomic sites of the surface plating finish 112. Thus, depositing metal ions at high current density 216 increases a number of vacancies that form in the surface plating finish 112. Exemplary vacancy production at high current density 216 is generally above about 20% atomic vacancies. Forming the surface plating finish 112 in the low current density region 212 reduces this number of vacancies in the surface plating finish 112 and, as a result, increases the gravitational density of the surface plating finish 112. The formation of atomic vacancies may be controlled by measuring and controlling an amount of hydrogen outgassing during the electroplating process.

When the metal of the surface plating finish is nickel, the gravitational density of surface plating finishes formed in the high current density region 216 is generally below about 80% of theoretical bulk nickel density. The plated metal density of surface plating finishes made in the medium current density region 214 may be between about 90% to about 99% of theoretical bulk nickel density. Alternately, the plated metal density formed in the low current density region 212 may be greater than about 99% of theoretical bulk nickel density. Since metal ion deposition occurs at a slower rate in the low current density region 212, it generally takes a longer time to form the surface plating finish 112 in this region. Thus, longer deposition times are used.

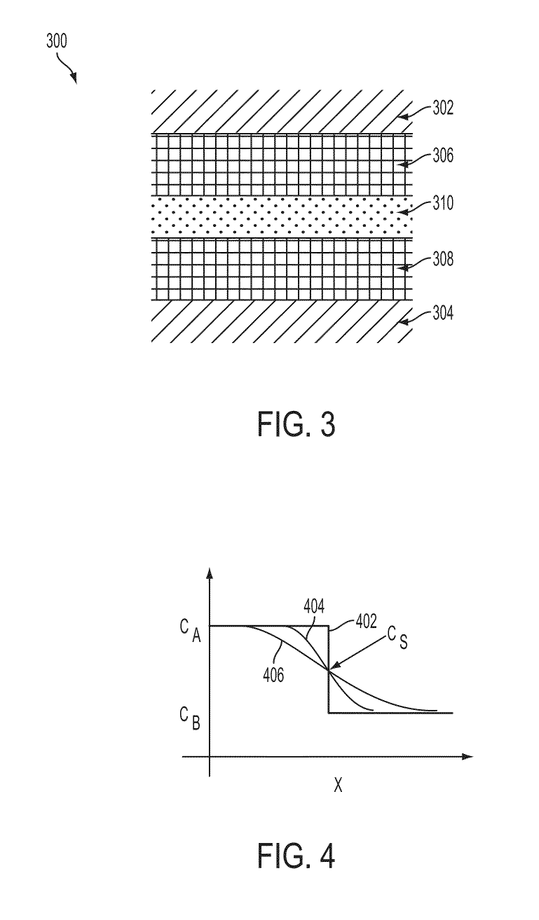

FIG. 3 shows a schematic configuration 300 of metals for forming an exemplary solder joint of the present disclosure. Components 302 and 304 are shown having surface plating finishes 306 and 308, respectively, formed thereon. In an exemplary embodiment, the surface plating finishes are nickel plating finishes. A solder material 310 is disposed between the surface plating finishes. In an exemplary embodiment, the solder material 310 is a gold-germanium metal. During a soldering process, the solder metal 310 and the surface plating finishes 306 and 308 are heated. The solder metal is raised above a reflow temperature of the solder metal 310, causing the solder metal 310 to liquefy and flow. As the solder metal flows, at least two mechanisms occur: diffusion of the atomic vacancies, and formation of nickel germanium intermetallic compounds in the solder joint. Exemplary nickel-germanium compounds include NiGe and Ni₅Ge₃. Generally, NiGe and Ni₅Ge₃ have different atomic spacing and thus do not align with each other or contribute to a formation of coherent ordered atomic lattices within the solder joint. Instead, the growth of NiGe and Ni₅Ge₃ provides a mechanism for aggregating the diffused atomic vacancies and thus for void formation in the solder joint and intermetallic compounds.

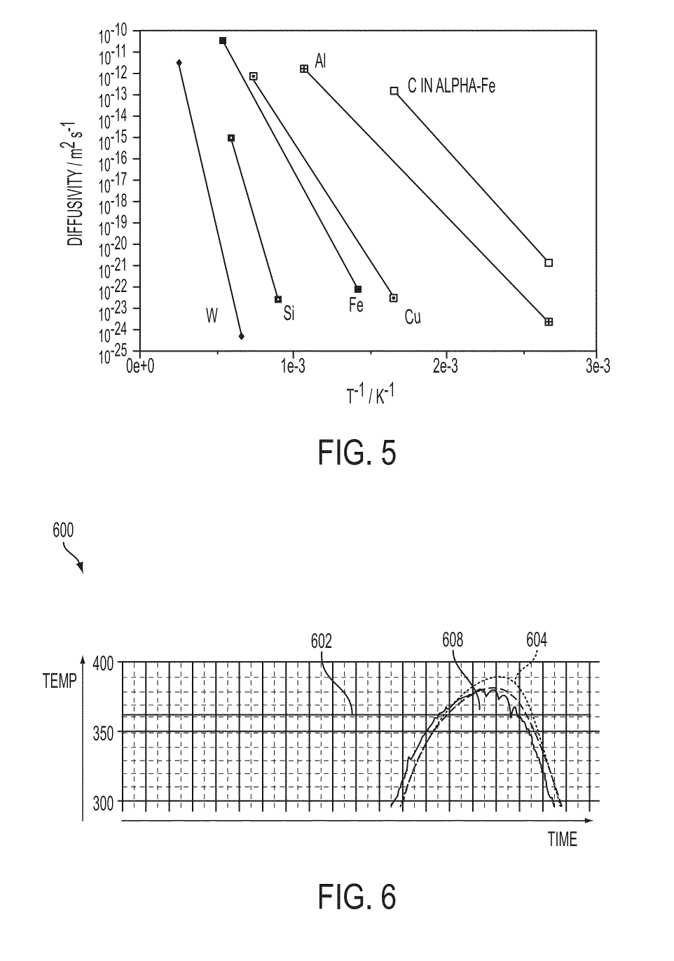

The rate of formation of the nickel-germanium compounds is related to various diffusion rates and plating thicknesses. FIG. 4 shows an exemplary diffusion at an interface between two layers having elements A (C_{A}) and B (C_{B}). Step function 402 shows concentration levels at time=0. Curve 404 shows concentration levels after a selected amount of diffusion time, and curve 406 shows concentration levels after a greater amount of diffusion time. The diffusion of the elements is generally described by an error function. Equation (1) below describes the diffusion profile of a composition:

$$C ( x , t ) = {C}_{n} - ( {C}_{n} - {C}_{0} ) erf \{ \frac{x}{2 \sqrt{Dt}} \} \qquad Eq . ( 1 )$$

where Cₙ is a concentration of element C at time t and C₀ is a concentration of element C at time t=0. Distance x measures a distance with respect to an interface between the nickel plating finish and the solder layer. D is the diffusion coefficient of the element C, which may be the nickel plating finishes 306 and 308 and/or the solder metal 310. The diffusion coefficient is generally temperature-dependent, as shown below in Equation (2):

$$D = {D}_{0} exp \{ \frac{{H}^{*}}{kT} \} \qquad Eq . ( 2 )$$

wherein D is the diffusion coefficient, H* is an activation enthalpy, k is Boltzmann's constant and T is temperature. FIG. 5 shows the exemplary graph of diffusion vs. temperature dependence of the diffusion coefficient. D₀ in Equation (2) is a value of diffusion determined as a y-intercept in FIG. 5.

FIG. 6 shows an exemplary heating curve 600 of the soldering process. Temperature is shown along the y-axis and time is shown along the x-axis. A reflow temperature 602 above which the solder liquefies is shown. For an exemplary gold-germanium solder metal, the reflow temperature is about 361 degrees Celsius. Curve 604 indicates the temperature applied to the solder joint during the soldering process. In one embodiment, the temperature applied during soldering process is controlled to reduce an area 608 bounded by curve 604 and reflow temperature 602, thus reducing a diffusion time as well as an amount of diffusion of the materials in the solder joint. In an exemplary embodiment, the temperature is raised above the reflow temperature by an amount in a range from about 10 degrees Celsius to about 20 degrees Celsius for a time in a range of about 1 minute to about 2 minutes. In an alternate embodiment, the temperature is raised above the reflow temperature by an amount in a range from about 20 degrees Celsius to about 40 degrees Celsius for a time in a range of about 2 minutes to about 5 minutes.

In another aspect, a thickness of the nickel plating finish is increased. Increasing the thicknesses of the nickel plating finish and the solderable gold plating finish (which overlays the nickel) reduces nickel diffusion, thereby reducing formation of nickel-germanium compounds in the solder joint and subsequently reducing void formation in the solder joint and intermetallic compounds. In standard soldering methods, nickel thicknesses range between about 100 micro-inches (2.54 micrometers (μm)) to about 150 micro-inches (3.81 μm) and gold thicknesses are generally less than about 50 micro-inches (1.27 μm).

Referring again to FIG. 3, in an exemplary embodiment, a thickness of the nickel in surface plating finishes 306 and 308 may be in a range from about 200 micro-inches (5.08 μm) to about 300 micro-inches (7.62 μm). The thickness of the solderable gold layer in surface plating finishes 306 and 308 is in a range between from about 100 micro-inches (2.54 μm) to about 150 micro inches (3.81 μm).

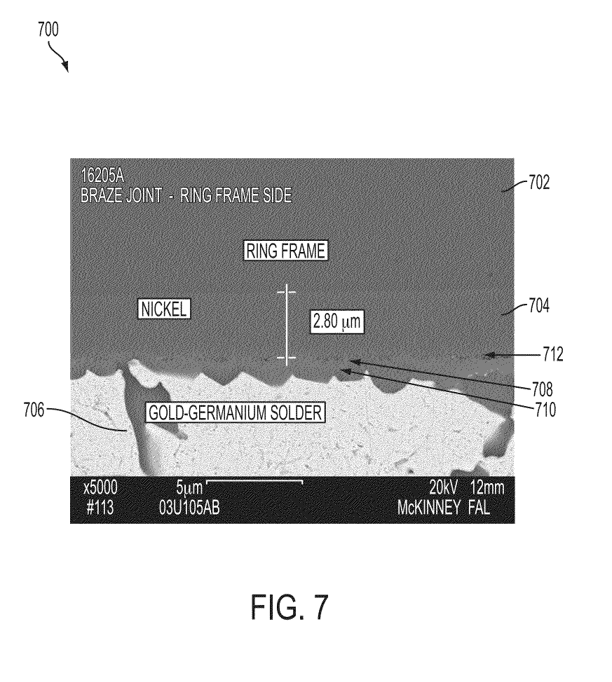

FIG. 7 (Prior Art) shows a cross-section of a solder joint 700 formed using standard methods of solder joint construction. The standard solder joint 700 includes a substrate 702 having nickel plating 704 formed thereon. The thickness of the nickel plating 704 is about 2.8 micrometers. Gold-germanium solder layer 706 is shown proximate the nickel plating 704. The soldering process creates intermetallic layers 708 and 710. Layer 708 includes a concentration of Ni₅Ge₃ compounds and layer 710 includes a concentration of NiGe compounds. Void formations 712 are shown along the interface between the nickel plating 704 and the Ni₅Ge₃ layer 708. The void formations of microporosity partially or completely link together to form a weak interface adjacent to the nickel plating 704. Thus, the standard solder joint 700 results in a leakage path and reduced hermeticity of the solder joint. Additionally, the standard solder joint may exhibit a reduced thermal conductivity and a reduced strength.

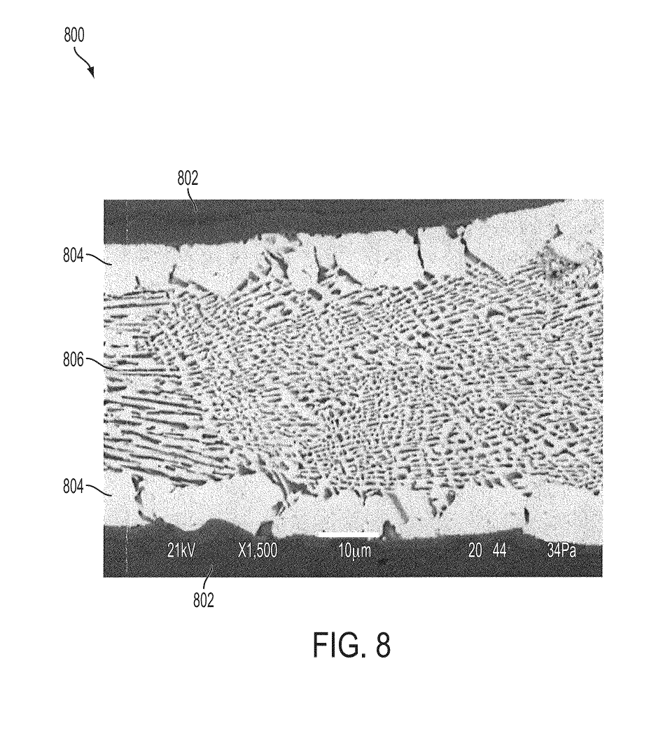

FIG. 8 shows a cross-section of an exemplary solder joint 800 formed using exemplary methods disclosed herein. The exemplary solder joint 800 is formed using low current density. The solder joint includes nickel plating layers 802, and gold plating layers 804 that are transformed into a gold rich phase during the soldering process. A gold-germanium solder layer 806 connects the gold plating layers 804. The exemplary solder joint 800 includes a number of voids or pores therein. Examination of the voids in a magnified image of the cross-section shows little or no connectivity between the voids. Thus, hermeticity, as well as thermal conductivity and solder joint strength, between the two nickel plating layers 802 is increased over the standard joint 700. In various embodiments, microporosity may be measured at various locations, including the surface plating finish, between the component and the plating, between the plating and a compound, between one compound layer and another compound layer, between a compound layer and the solder, and between one solder phase and another solder phase, for example.

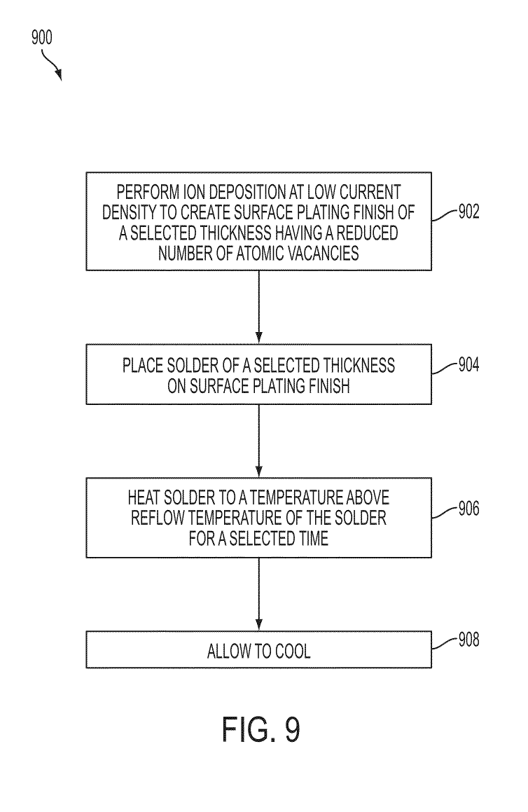

FIG. 9 shows a flowchart 900 illustrating an exemplary method of solder joint construction using the exemplary methods disclosed herein. The exemplary method may be applied to any solder joint having any surface plating finish materials and designs as well as any solder compositions and designs. In box 902, a surface plating finish is formed on a component that is to be soldered. The surface plating finish is formed using metal ion deposition at a low current density to reduce hydrogen evolution and thereby reduce the formation of vacancies at atomic lattice locations in the surface plating finish. In box 904, solder is placed on the surface plating finish, wherein the solder is of a selected thickness. In box 906, the solder is heated to a selected temperature above its reflow temperature for a selected amount of time. The selected temperature and selected time are selected to reduce a diffusion of vacancies. In box 908, the solder is allowed to cool.

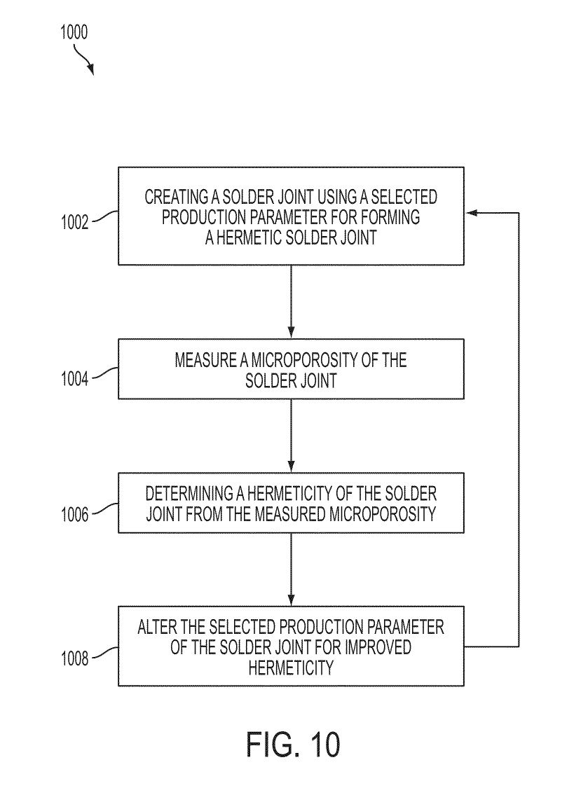

FIG. 10 shows a flowchart 1000 illustrating an exemplary method of controlling a quality of a hermeticity of a solder joint. The exemplary method may be applied to any solder joint having any surface plating finish materials and designs as well as any solder compositions and designs. In box 1002, a solder joint is created using a selected production parameter of the production process, i.e., current density, a throwing power of the electroplating process, etc. In box 1004, a microporosity of the solder joint is measured. The microporosity may be measured, for example, by observing a magnified cross-section of the solder joint. The microporosity may be measured in locations and/or interfaces that include, for example, the surface plating finish, between the component and the plating, between the plating and a compound, between one compound layer and another compound layer, between a compound layer and the solder, and/or between one solder phase and another solder phase. In box 1006, hermeticity of the solder joint is determined from the measured microporosity. The improvement in hermeticity, thermal conductivity and/or strength occurs when microporosity is avoided at the internal interfaces of the solder joint. In box 1008, the selected production parameter is altered to improve the hermeticity and the selected production parameter is then used to create a new solder joint having an improved hermeticity.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The flow diagrams depicted herein are just one example. There may be many variations to this diagram or the steps (or operations) described therein without departing from the spirit of the disclosure. For instance, the steps may be performed in a differing order or steps may be added, deleted or modified. All of these variations are considered a part of the claimed disclosure.

While an exemplary embodiment of the disclosure has been described, it will be understood that those skilled in the art, both now and in the future, may make various improvements and enhancements which fall within the scope of the claims which follow. These claims should be construed to maintain the proper protection for the disclosure first described.

What is claimed is:

1. A method of soldering a component, comprising:
controlling a formation of atomic vacancies in a surface layer of the component; and
controlling a diffusion rate of the atomic vacancies during soldering of the material.

2. The method of claim 1, wherein the surface layer is a surface plating finish electroplated onto the component, the method further comprising controlling an electroplating current density of the electroplating process to control the formation of the atomic vacancies in the surface plating finish.

3. The method of claim 2, wherein the electroplating current density is in a range from about 0.2 amps per square decimeter to about 5 amps per square decimeter.

4. The method of claim 2, further comprising electroplating the surface plating finish at a selected current density below a current density at which hydrogen evolution occurs in the surface plating finish.

5. The method of claim 4, further comprising controlling the formation of atomic vacancies by measuring an amount of hydrogen outgassing during the electroplating process.

6. The method of claim 1, wherein controlling the diffusion further comprises applying a solderable gold plating finish to the material, wherein a thickness of the gold is in a range from about 100 micro-inches (2.54 μm) to about 150 micro-inches (3.81 μm).

7. The method of claim 1, wherein controlling the diffusion rate further comprises reducing a temperature and time for which the solder is above a solder reflow temperature.

8. The method of claim 1, wherein controlling the diffusion rate further comprises forming the surface layer to a thickness in a range from about 200 micro-inches (5.08 μm) to about 300 micro-inches (7.62 μm).

9. The method of claim 8, wherein the plated surface finish is composed of nickel and the solder material is composed of gold-germanium.

10. The method of claim 1, further comprising controlling at least one of a void formation in a solder joint and formation of nickel-germanium compounds in the solder joint.

11. A method of improving a hermeticity of a solder joint, comprising:
controlling a parameter related to formation of atomic vacancies in a material forming the solder joint; and
controlling a diffusion rate of the atomic vacancies during soldering of the material to form the solder joint.

12. The method of claim 11, wherein controlling the parameter related to the formation of atomic vacancies further comprises controlling an electroplating current density of the electroplating process that forms the material.

13. The method of claim 11, further comprising measuring a microporosity of the solder joint and altering one of the parameters related to formation of atomic vacancies and the diffusion rate of the atomic vacancies when the microporosity meets a selected criterion.

14. The method of claim 13, further comprising measuring the microporosity at at least one of: the surface plating finish, between the component and the plating, between the plating and a compound, between one compound layer and another compound layer, between a compound layer and the solder, and between one solder phase and another solder phase.

15. The method of claim 11, further comprising controlling the formation of atomic vacancies by measuring an amount of hydrogen outgassing during the electroplating process.

16. The method of claim 11, wherein controlling the diffusion rate further comprises controlling a surface layer to a thickness in a range from about 200 micro-inches (5.08 μm) to about 300 micro-inches (7.62 μm) and controlling a thickness of a solderable gold plating finish to within a range from about 100 micro-inches (2.54 μm) to about 150 micro-inches (3.81 μm).

17. The method of claim 11, wherein controlling the diffusion rate further comprises reducing a temperature and time for which the solder is above a solder reflow temperature.

18. A solder joint, comprising:
a component;
a surface plating finish formed on the component having a controlled number of atomic vacancies; and
a solder layer and intermetallic compounds having a controlled number of voids.

19. The solder joint of claim 18, wherein a thickness of the surface plating finish is in a range from about 200 micro-inches (5.08 μm) to about 300 micro-inches (7.62 μm) and a thickness of a solderable gold plating finish is in a range from about 100 micro-inches (2.54 μm) to about 150 micro-inches (3.81 μm).

20. The solder joint of claim 18, wherein at least one of a microporosity of the solder joint and a connectivity of the voids in the solder joint is reduced over a standard joint.
